(19) United States
(12) Patent Application Publication
(10) Pub. No.: US 2016/0019256 A1
(43) Pub. Date: Jan. 21, 2016

(54) System and Method for Updating Online Business Listings

(71) Applicant: Google Inc., Mountain View, CA (US)

(72) Inventors: Brian Edmond Brewington, Fort Collins, CO (US); Brian Gammon Brown, Longmont, CA (US)

(73) Assignee: Google Inc., Mountain View, CA (US)

(21) Appl. No.: 13/968,475

(22) Filed: Aug. 16, 2013

(51) Int. Cl. G06F 17/30

(52) U.S. Cl. CPC G06F 17/30371

(57) ABSTRACT

In one aspect, a computer-implemented method for updating online business listings includes providing access to an email account associated with a business entity and receiving an indication of a change in a signature block associated with the email account. The signature block may include business data related to the business entity. The method may also include accessing a business listing database to determine whether a pre-existing online listing is available for the business entity and, if a pre-existing online listing is available for the business entity, comparing the business data contained within the signature block to pre-existing business data included within the pre-existing online listing. In addition, the method may include determining whether to update the pre-existing online listing based on any differences between the business data and the preexisting business data.

### FIELD

The present subject matter relates generally to online business listings and, more particularly, to a system and method for updating online business listings based on changes in business data transmitted via email communications and/or other electronic communications.

### BACKGROUND

Various online data providers are available that provide commercial or business listings for business. For instance, through the online services provided by Google, Inc. (e.g., Google Web Search, Google Maps, etc.), users may search for a particular business and find an online business listing providing various types of business data associated with the entity, such as the business name, mailing address, web address, hours of operation and/or the like.

Given the increased reliance on online-based information in today's society, businesses can benefit greatly from having accurate online listings. Specifically, by providing its current contact information and other business data for use within an online listing, a local business may increase its customer exposure significantly. Unfortunately, it is often an administrative burden for businesses (particularly small businesses) to keep their online-based data up-to-date. As a result, online business listings often contain inaccurate and/or outdated information.

### SUMMARY

Aspects and advantages of the invention will be set forth in part in the following description, or may be obvious from the description, or may be learned through practice of the invention.

In one aspect, the present subject matter is directed to a computer-implemented method for updating online business listings. The method may generally include providing access to an email account associated with a business entity and receiving an indication of a change in a signature block associated with the email account. The signature block may include business data related to the business entity. The method may also include accessing a business listing database to determine whether a pre-existing online listing is available for the business entity and, if a pre-existing online listing is available for the business entity, comparing the business data contained within the signature block to pre-existing business data included within the pre-existing online listing. In addition, the method may include determining whether to update the pre-existing online listing based on any differences between the business data and the preexisting business data.

In another aspect, the present subject matter is directed to a system for updating online business listings. The system may include a computing device having a processor and associated memory. The memory may store instructions that, when executed by the processor, configure the computing device to provide access to an email account associated with a business entity and receive an indication of a change in a signature block associated with the email account. The signature block may include business data related to the business entity. The computing device may also be configured to access a business listing database to determine whether a pre-existing online listing is available for the business entity and, if a pre-existing online listing is available for the business entity, compare the business data contained within the signature block to pre-existing business data included within the pre-existing online listing. In addition, the computing device may be configured to determine whether to update the pre-existing online listing based on any differences between the business data and the preexisting business data.

In a further aspect, the present subject matter is directed to a tangible, non-transitory computer-readable medium storing computer-executable instructions that, when executed by one or more processors, cause the one or more processors to perform specific operations. The operations may include providing access to an email account associated with a business entity and receiving an indication of a change in a signature block associated with the email account. The signature block may include business data related to the business entity. The operations may also include accessing a business listing database to determine whether a pre-existing online listing is available for the business entity and, if a pre-existing online listing is available for the business entity, comparing the business data contained within the signature block to pre-existing business data included within the pre-existing online listing. In addition, the operations may include determining whether to update the pre-existing online listing based on any differences between the business data and the preexisting business data.

Other exemplary aspects of the present disclosure are directed to systems, apparatus, non-transitory computer-readable media, user interfaces and devices for associating tags with online content.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic diagram of one embodiment of a system for updating online business listings in accordance with aspects of the present subject matter;

FIG. 2 illustrates an example of a signature block that may be included within an email communication, particularly illustrating certain business data contained within the signature block;

FIG. 3 illustrates a flow diagram of one embodiment of a method for updating online business listings in accordance with aspects of the present subject matter;

FIG. 4 illustrates an example of a user interface that may be presented to a user to verify that an online business listing is associated with a particular business entity in accordance with aspects of the present subject matter; and

FIG. 5 illustrates an example of a user interface that may be presented to a user to verify that an online business listing should be updated in accordance with aspects of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and method for updating online business listings. Specifically, in several embodiments, an online business listing(s) for a particular business entity may be updated based on changes in the signature block(s) associated with electronic communications transmitted by employees and/or other persons associated with the business entity. For instance, a business entity may have one or more email accounts through which its employees receive and transmit email communications. If a signature block(s) is associated with the email account(s), changes in the business data contained within the signature block(s) may be detected. For instance, if the business entity changes its mailing address, employees of the business entity may update the signature block(s) associated with the email account(s) to reflect such change. By detecting changes in the signature block, one or more online listings for the business entity may be created and/or updated based on the business data contained within signature block.

It should be appreciated that, in general, the present subject matter will be described herein with reference to email communications sent by a client device via an email application hosted by a server. However, the disclosed system and method may generally be utilized in connection with any electronic communication that may be transmitted via a suitable communications application, such as text messages, voice messages (via voice-to-text functionality), social networking-based communications and/or any other suitable electronic correspondence.

It should also be appreciated that the technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

In addition, in situations in which the systems and methods discussed herein access and/or analyze content for use within email communications and/or other electronic communications that may contain personal information about users (e.g., signature blocks), the users may be provided with an opportunity to control whether programs or features may actually access such information. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

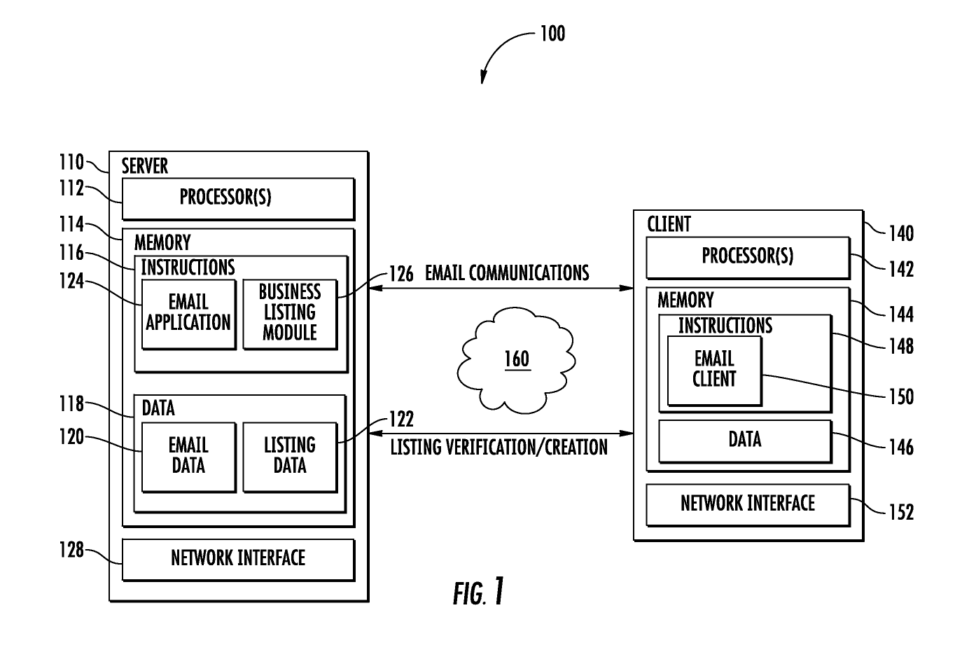

Referring now to the drawings, FIG. 1 illustrates one embodiment of a system 100 for updating online business listings in accordance with aspects of the present subject matter. As will be described below, the system 100 may allow for a change in the business data related to a business entity to be detected based on changes in the textual content included within signature blocks or other contact information provided by users associated with the entity. Once the change in business data is detected, it may be determined whether an existing online listing(s) for the business entity needs to be updated or if a new online listing(s) needs to be created based on the changed business data.

As shown in FIG. 1, the system 100 may include a client-server architecture where a server 110 communicates with one or more clients, such as a local client device 140, over a network 160. The server 110 may generally be any suitable computing device(s), such as a web server(s). Similarly, the client device 140 may generally be any suitable computing device(s), such as a laptop(s), desktop(s), smartphone(s), tablet(s), mobile device(s), wearable computing device(s) and/or any other computing device(s). Although a single client device 140 is shown in FIG. 1, it should be appreciated that any number of clients may be connected to the server 110 over the network 160.

In several embodiments, the server 110 may be configured to host a communications application, such as an email application (e.g. Gmail provided by Google Inc.), a social networking application, a voice and/or text messaging application and/or any other suitable communications application that allows users to transmit electronic communications between one another. On the client-side, the client device 140 may present a user interface that allows a user to interact with the communications application. For instance, the user interface may be served through a network or web-based application that is executed on the client device 140, such as a web browser, a thin client application or any other suitable network or web-based application or the user interface may be served locally on the client device 140.

As shown in FIG. 1, the client device 140 may include one or more processors 142 and associated memory 144. The processor(s) 142 may be any suitable processing device known in the art, such as a microprocessor, microcontroller, integrated circuit, or other suitable processing device. Similarly, the memory 144 may be any suitable computer-readable medium or media, including, but not limited to, non-transitory computer-readable media, RAM, ROM, hard drives, flash drives, or other memory devices. As is generally understood, the memory 144 may be configured to store various types of information, such as data 146 that may be accessed by the processor(s) 142 and instructions 148 that may be executed by the processor(s) 142. The data 146 may generally correspond to any suitable files or other data that may be retrieved, manipulated, created, or stored by processor(s) 142. In several embodiments, the data 146 may be stored in one or more databases.

Additionally, the instructions 148 stored within the memory 144 of the client device 140 may generally be any set of instructions that, when executed by the processor(s) 142, cause the processor(s) 142 to provide desired functionality. For example, the instructions 148 may be software instructions rendered in a computer readable form or the instructions may be implemented using hard-wired logic or other circuitry. In several embodiments, the instructions 148 stored within the memory 144 may be executed by the processor(s) 142 to implement a communications client that allows a user to interface with the communications application hosted by the server 110, which may provide a means for electronic communications to be sent and received by the client device 140.

For instance, as shown in FIG. 1, in several embodiments, the communications client may be a web-based or local email client 150 configured to communicate with a corresponding email application 124 hosted by the server 110. In general, the email client 150 may be configured to present a user interface that allows a user to interface with the email application 124 in order to send and receive email communications. For instance, the user interface may allow the user to log-on to an email account associated with his/her email address by providing a username/password and/or any other suitable identifying information. Email communications associated with the email account may then be viewed and/or downloaded onto the client device 140. Additionally, new email communications may be created within the user interface and transmitted from the client device 140 to the server 110.

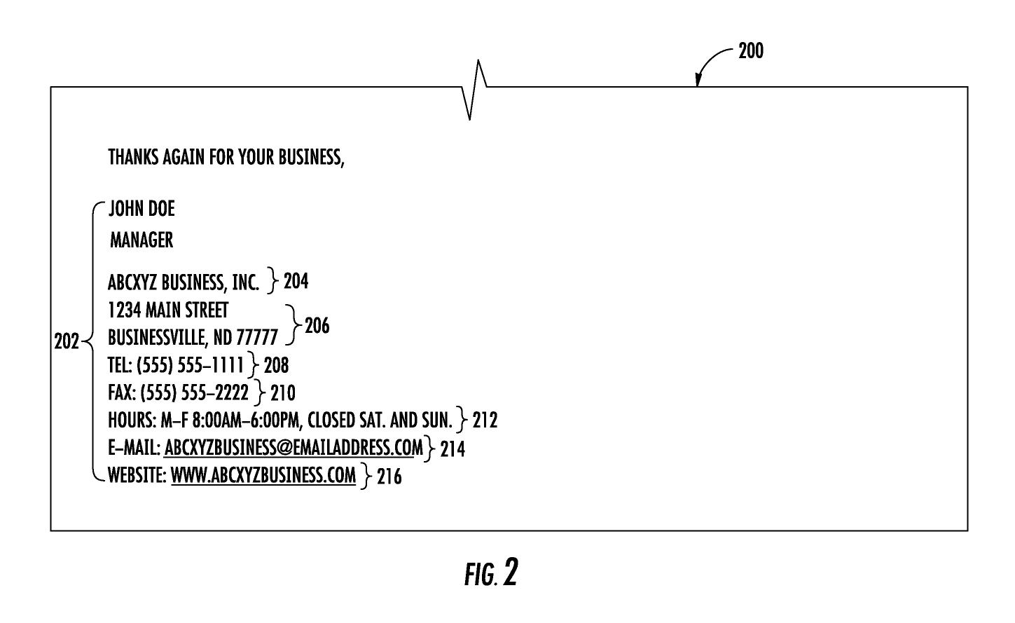

As is generally understood, when sending an email communication, a user may often utilize a signature block to provide useful information to the recipient of the email. Thus, when the user is an employee of or is otherwise associated with a business entity, the signature block may include business data related to such business entity. For instance, FIG. 2 illustrates an example view of a portion of an email communication 200 including a signature block 202 containing business data. As shown, the signature block 202 may include various types of business data associated with a particular business entity, such as the business name 204, mailing address 206, telephone number 208, fax number 210, hours of operation 212, email address 214 and website address 216.

It should be appreciated that, as used herein, the term “signature block” generally refers to recurring textual content or other data, contained within, attached to and/or accessible via an electronic communication, which includes identifying information about the sender and/or information about the business entity with which the sender is associated. Typically, a user configures his/her email settings so that the signature block is automatically appended to the end or bottom of an email communication as specific textual content. However, signature blocks may also be inserted manually on a communication-by-communication basis and may also be positioned at any other suitable location within an email communication. In addition, signature blocks may also be attached to an email communication. For instance, signature blocks containing business data may often be attached to an email communication as an image file or any other suitable file (e.g., a VCF file). In such instance, the data contained within the attachment may be considered all or part of the signature block associated with the email communication. Similarly, signature blocks may also be accessible via a link contained within an email communication. For instance, a web link may be included within an email communication that provides access to a business profile (e.g., a profile associated with the Google+ services provided by Google, Inc.) or any other suitable web-based content containing business data associated with a business entity. In such instance, the data contained within the linked, web-based content may be considered all or part of the signature block associated with the email communication. Moreover, it should be appreciated that, although the signature block 202 of FIG. 2 is shown as being included within an email communication 200, signature blocks may generally be included within any suitable electronic communication.

It should also be appreciated that, as used herein, the term “business data” generally refers to any information associated with a business entity. Specifically, in several embodiments, the term “business data” is used to refer to data that provides contact information for the business entity and/or information related to the operation of the business entity, such as the business name, mailing address, telephone number, fax number, email address, website address, hours of operation and/or the like.

Referring back to FIG. 1, the client device 140 may also include a network interface 152 for providing communications over the network 160. In general, the network interface 152 may be any device/medium that allows the client device 140 to interface with the network 160.

Similar to the client device 140, the server 110 may also have a processor(s) 112 and a memory 114. The processor(s) 112 may be any suitable processing device, such as a microprocessor, microcontroller, integrated circuit, or other suitable processing device. Similarly, the memory 114 may include any suitable computer-readable medium or media, including, but not limited to, non-transitory computer-readable media, RAM, ROM, hard drives, flash drives, or other memory devices. The memory 114 may store information accessible by processor(s) 112, including instructions 116 that can be executed by processor(s) 112 and data 118 that can be retrieved, manipulated, created, or stored by processor(s) 112. In several embodiments, the data 118 may be stored in one or more databases. The one or more databases may, for example, be connected to the server 110 by a high bandwidth LAN or WAN and/or or may be connected to the server 110 through the network 160. In addition, the one or more databases may be split up so that they are located in multiple locales.

For instance, as shown in FIG. 1, the memory 114 may include an email database 120 for storing data associated with the email accounts accessible via the email application 124 hosted by the server 110. For instance, the email database 120 may store email messages that may be accessed by and/or downloaded to the client device 140 via the email client 150. In addition, the email database 120 may also include various other types of data associated with the email application 124, such as email settings (including any signature block(s)) associated with the various email accounts. In addition, the memory 114 may also include a listing database 122 for storing data associated with online business listings. Specifically, the listing database 122 may correspond to a compilation of online business listings, with each business listing including business data associated with a specific business entity.

As indicated above, the server 110 may be configured to host a communications application, such as an email application 124. Thus, in several embodiments, the instructions 116 stored within the memory 114 that may be executed by the processor(s) 112 to allow the server 110 to utilize one or more suitable communications protocols (e.g., POP3, IMAP and/or STMP) to allow for the transmission of email communications. In such embodiments, a user may utilize the email client 150 implemented on his/her client device 140 to send and receive email communications via the email application 124.

By hosting the email application 124, the server 110 may be configured to detect changes in the business data for a local business entity by identifying changes in the signature block used for an email account(s) associated with the business entity. Specifically, in several embodiments, the server 110 may be configured to detect when a user(s) of the email account(s) submits a request to associate a new or updated signature block with future email communications, such as when the user(s) creates a new signature block or changes an existing signature block within the email settings associated with the email account(s).

Additionally, as shown in FIG. 1, the instructions 116 stored within the memory 114 may also be executed by the processor(s) 112 to implement a business listing module 126. In general, the business listing module 126 may be configured to create and/or update the online business listings associated with local business entities based on changes in the business data associated with such entities. For instance, as will be described below, when it is determined that a change has been made to the business data contained within a signature block associated with a local business entity, the business listing module 126 may be configured to access the listing database 122 to determine if a pre-existing online listing is available for the business entity. If so, the business listing module 126 may compare the business data contained within the signature block to the business data contained within the pre-existing online listing. If differences exist, the business listing module 126 may then initiate a suitable process to update the business data contained within pre-existing online listing with any differing business data contained within the signature block. Alternatively, if a pre-existing online listing is not available for the business entity, the business listing module 126 may initiate a suitable process for creating a new online listing for the entity.

It should be appreciated that, as used herein, the term “module” refers to computer logic utilized to provide desired functionality. Thus, a module may be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, ROM, hard disk or optical or magnetic media.

Additionally, as shown in FIG. 1, the server 110 may also include a network interface 128 for providing communications over the network 160. Similar to the interface 152 for the client device 140, the network interface 128 may generally be any device/medium that allows the server 110 to interface with the network 160.

It should be appreciated that the network 160 may be any type of communications network, such as a local area network (e.g. intranet), wide area network (e.g. Internet), or some combination thereof. The network may also include a direct connection between the client device 140 and the server 110. In general, communication between the server 110 and the client device 140 may be carried via a network interface using any type of wired and/or wireless connection, using a variety of communication protocols (e.g. TCP/IP, HTTP, SMTP, FTP), encodings or formats.

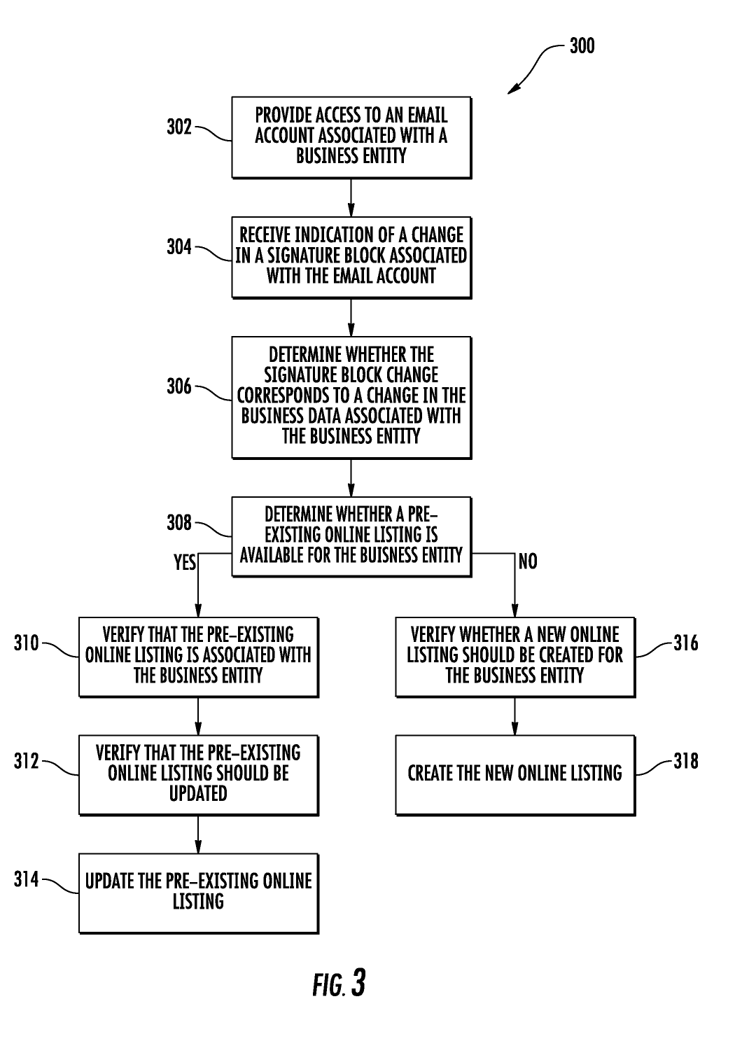

Referring now to FIG. 3, a flow diagram of one embodiment of a method 300 for updating online business listings is illustrated in accordance with aspects of the present subject matter. The method 300 will generally be discussed herein with reference to the system 100 shown in FIG. 1. However, those of ordinary skill in the art, using the disclosures provided herein, should appreciate that the methods described herein may be executed by any computing device or any combination of computing devices. Additionally, it should be appreciated that, although the method elements 302-318 are shown in FIG. 3 in a specific order, the various elements of the disclosed method 300 may generally be performed in any suitable order that is consistent with the disclosure provided herein.

It should also be appreciated that, although the method 300 will generally be described herein with reference to detecting changes in the signature block associated with an email account(s), elements of the disclosed method 300 may be utilized to allow online business listings to be updated based on changes in the textual content associated with any suitable electronic communication, such as text messages, voice messages (e.g., via voice-to-text functionality), social networking-based communications and/or the like.

As shown in FIG. 3, at (302), the method 300 includes providing access to an email account associated with a local business entity. For instance, as indicated above, the server 110 may be configured to host an email application 124. Thus, in several embodiments, the server 110 may be configured to provide access to one or more email accounts by communicating with a suitable email client 150 running on a client device (e.g., client device 140). For example, a business entity may have one or more email accounts hosted by the server 110 that are used by its employees or other users associated with the business entity to send and receive email communications. Accordingly, users may communicate with the server 110, via the user interface presented by the email client(s) 150, to access the email account(s) associated with the business entity.

At (304), the method 300 includes receiving an indication of a change in a signature block associated with an email account used in connection with the business entity. As indicated above, by hosting the email application 124, the server 110 may be configured to detect when a user attempts to change the signature block associated with an email account. For instance, in several embodiments, a user may access his/her email settings via the user interface presented by the email client 150 to create a new signature block or to change a pre-existing signature block. In such embodiments, the server 110 may be configured to receive an indication of a change in the signature block associated with the corresponding email account when the user provides a suitable user input indicating that the new or updated signature block is to be utilized with future email communications (e.g., by clicking a save or submit button presented on the user interface in order to transmit a request to the server 110 to create or update a particular signature block). Alternatively, the server 110 may be configured to detect changes in the signature block associated with an email account using any other suitable means.

Referring still to FIG. 3, at (306), the method 300 includes determining whether the change in the signature block corresponds to a change in the business data associated with the local business entity. For instance, in several embodiments, the textual content of the new or updated signature block may be parsed to identify the business data contained therein, such as by identifying the name, mailing address, telephone number, fax number, email address, website address and/or hours of operation associated with the business entity. Thereafter, it may be determined whether such business data has actually been changed in the signature block. For instance, for a new signature block, any business data contained therein may be considered “changed” for the purpose of performing the disclosed method 300. For an existing signature block that has been updated or changed, the business data contained therein may be compared to the business data contained within a previous signature block stored within the email database 120 (e.g., the previous signature block provided in the email settings associated with the email account) to determine if such data has been changed.

In several embodiments, if it is found that the change in the signature block corresponds to a change in at least a portion of the business data contained therein, at (308), the method 300 includes determining whether a pre-existing online listing is available for the business entity associated with the business data. For example, as indicated above, the server 110 (via the business listing module 126) may be configured to access a listing database 122 storing data associated with online business listings. As such, the server 110 may access and search the business listings stored on the database 122. For instance, the server 110 may be configured to search by business name, mailing address and/or any other suitable business data contained within the signature block to determine if a pre-existing online listing is available for the business entity.

If a business listing is found that may be associated with the business entity for which the changed signature block has been detected (e.g., due to the listing containing business data the matches all or a portion of the business data contained with the signature block), at (310), the method 300 includes verifying that the pre-existing listing is actually associated with such business entity. For instance, in several embodiments, the server 110 may be configured to transmit an electronic verification request to the user(s) of the email account to determine if the pre-existing listing is related to the business entity. The verification request may correspond to, for example, an email communication or any other suitable electronic correspondence requesting that the user(s) verify the association of the business entity with the online business listing. In a particular embodiment, the verification request may be displayed to the user(s) automatically when such user(s) submits a request to create a new signature block or to change an existing signature block within the email settings of the corresponding email account. For instance, upon receiving the signature block create/change request from the client device 140, the server 110 may be configured to search the listing database 122 and transmit back to the client device 140 any pre-existing online listing found that may be associated with the business entity. The user may then view the data contained within the online listing via a user interface displayed on the client device 140 to determine whether the listing is associated with the corresponding business entity.

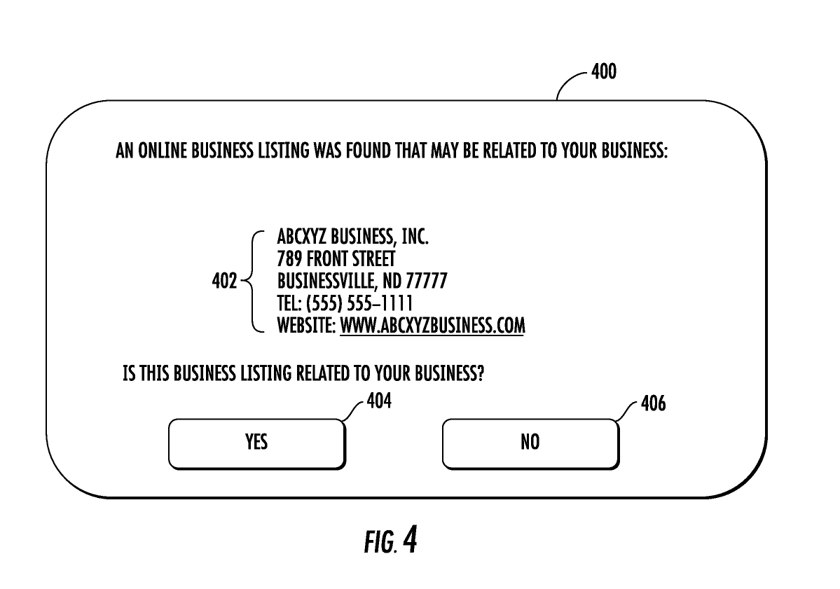

For instance, FIG. 4 illustrates one example of a suitable user interface 400 that may be utilized to present the verification request of (310) to a user. As shown, the user interface 400 is configured to display the business data 402 associated with the pre-existing online listing identified by the server 110. For example, in the illustrated embodiment, the business data 402 contained within the pre-existing online listing is similar to that contained within the signature block 202 shown in FIG. 2 (except for a different business address). In such instance, a user of the email account associated with the signature block 202 may be able to verify whether some or all of the business data presented within the user interface 400 is related to the business entity identified in the signature block 202 (e.g., by selecting one of the user input buttons 404, 406). For example, the business entity may have recently moved to a new address and, although the signature block 202 for the email account associated with the entity may have been updated, the online business listing available for the entity may still contain the old mailing address. Thus, by reviewing the remainder of the business data contained within the pre-existing online listing, the user may be able to verify that the listing presented in the user interface 400 is associated with the corresponding business entity.

It should be appreciated that, in alternative embodiments, it may be determined whether the business entity is associated with the pre-existing online listing using any other suitable verification process. For instance, upon finding one or more listings that may be associated with the business entity, the server 110 may be configured to trigger a follow-up verification process, such as by triggering an automatic mailing or phone call to the business entity to verify its association with the pre-existing online listing.

Referring back to FIG. 3, if it is verified that the pre-existing online listing is associated with the business entity, at (312), the method 300 includes verifying whether the pre-existing online listing should be updated with the business data contained within the changed signature block. For instance, in several embodiments, the server 110 may be configured to transmit an electronic verification request to the user(s) of the email account to determine if the online listing should be updated. Similar to the verification request described above with reference to (310), the request associated with (312) may generally correspond to any suitable electronic correspondence.

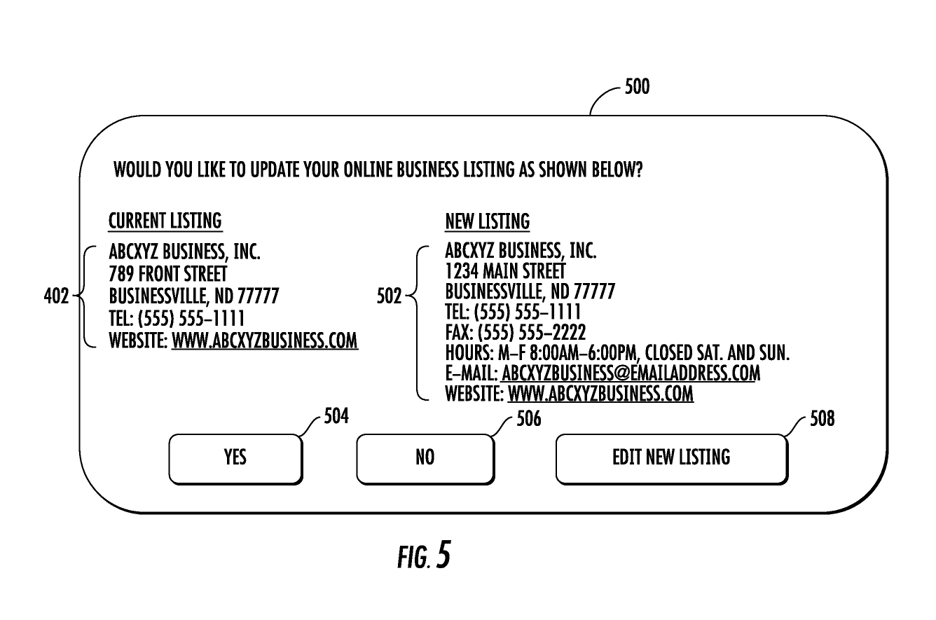

For instance, FIG. 5 illustrates one example of a suitable user interface 500 that may be presented to a user in response to an affirmative user input received in relation to the user interface 400 shown in FIG. 4. As shown, the user interface 500 is configured to display both the pre-existing online listing (including its corresponding business data 402) and a proposed, updated listing including all or a portion of the business data 502 contained within the changed signature block (e.g., signature block 202). The user may then determine whether or not the pre-existing online listing should be updated to the new listing shown (e.g., by selecting one of the input buttons 504, 506). In addition, the user may also be provided the option (e.g., upon selection of input button 508) to edit the new listing (e.g., by adding new business data to the listing or by removing/editing the business data contained therein). Alternatively, it may be verified that the pre-existing online listing should be updated using any other suitable verification process, such as by triggering an automatic mailing or a phone call to the business entity to verify whether or not the pre-existing listing should be updated.

Referring back to FIG. 3, upon verifying that the pre-existing online listing should be updated, at (312), the online listing may be updated. For instance, the server 110 may be configured to replace the pre-existing online listing stored on the listing database 122 with a new listing containing the updated business data. It should be appreciated that, in alternative embodiments, the server 110 may be configured to update the pre-existing online listing without requiring the verification steps provided for in (310) and/or (312).

Referring still to FIG. 3, in the event that a pre-existing online listing is not available for the business entity, at (316), the method 300 includes verifying whether a new online listing should be created for the entity. For instance, in several embodiments, the server may be configured to transmit an electronic verification request to the user(s) of the email account to determine whether it is desired for a new online listing to be created for the business entity. As indicated above, the verification request may correspond to, for example, an email communication or any other suitable electronic correspondence requesting that the user(s) verify that a new online listing should be created. For instance, in a particular embodiment, the verification request may be displayed to the user(s) automatically when such user(s) submits a signature block create/change request to create a new signature block or change an existing signature block within the email settings of the corresponding email account. In such an embodiment, the user interface displayed to the user(s) may include a copy of the proposed, new online listing and/or may allow the user(s) to edit/create the new listing. Alternatively, it may be verified that a new online listing should be created using any other suitable verification process, such as by triggering a mailing or a phone call to the business entity.

Upon verification that the new listing should be created, at (318), the method 300 includes creating the new online listing. For instance, the server 110 may be configured to create a new data subset or file within the listing database 122 that includes the business data contained within the changed signature block (e.g., signature block 202). It should be appreciated that, in alternative embodiments, the server may be configured to create the new online listing without requiring the verification step provided for in (316).

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method for updating online business listings, the method comprising:
providing, with a computing device, access to an email account associated with a business entity;
receiving, with the computing device, an indication of a change in a signature block associated with the email account, the signature block including business data related to the business entity;
accessing, with the computing device, a business listing database to determine whether a pre-existing online listing is available for the business entity, the pre-existing online listing corresponding to a business listing that is different from the signature block associated with the email account;
if a pre-existing online listing is available for the business entity, comparing, with the computing device, the business data contained within the signature block to pre-existing business data included within the pre-existing online listing; and
determining, with the computing device, whether to update the pre-existing online listing based on any differences between the business data and the preexisting business data,
wherein determining whether to update the pre-existing online listing includes automatically transmitting, with the computing device, a request to a user of the email account to verify that the pre-existing online listing is associated with the business entity.

2. The method of claim 1, wherein the business data includes at least one of a name, address, telephone number, fax number, website address or hours of operation of the business entity.

3. The method of claim 1, further comprising determining whether the change in the signature block corresponds to a change in the business data contained within the signature block.

4. The method of claim 1, wherein receiving the indication of the change in the signature block comprises receiving a request associated with changing at least a portion of the business data contained within the signature block.

5. The method of claim 1, wherein receiving the indication of the change in the signature block comprises receiving a request associated with creating the signature block.

6. (canceled)

7. The method of claim 1, wherein determining whether to update the pre-existing online listing further includes transmitting a request to the user of the email account to verify that the pre-existing online listing should be updated based on the differences between the business data and the preexisting business data.

8. The method of claim 1, further comprising updating the pre-existing online listing based on the differences between the business data and the preexisting business data.

9. (canceled)

10. A system for updating online business listings, the system comprising:
a computing device including a processor and associated memory, the memory storing instructions that, when executed by the processor, configure the computing device to:
provide access to an email account associated with a business entity;
receive an indication of a change in a signature block associated with the email account, the signature block including business data related to the business entity;
access a business listing database to determine whether a pre-existing online listing is available for the business entity, the pre-existing online listing corresponding to a business listing that is different from the signature block associated with the email account;
if a pre-existing online listing is available for the business entity, compare the business data contained within the signature block to pre-existing business data included within the pre-existing online listing; and
determine whether to update the pre-existing online listing based on any differences between the business data and the preexisting business data, at least in part, by automatically transmitting a request to a user of the email account to verify that the pre-existing online listing is associated with the business entity.

11. The system of claim 10, wherein the business data includes at least one of a name, address, telephone number, fax number, website address or hours of operation of the business entity.

12. The system of claim 10, wherein the computing device is further configured to determine whether the change in the signature block corresponds to a change in the business data contained within the signature block.

13. The system of claim 10, wherein the indication of the change in the signature block is provided via receipt by the computing device of a request associated with changing at least a portion of the business data contained within the signature block.

14. The system of claim 10, wherein the indication of the change in the signature block is provided via receipt by the computing device of a request associated with creating the signature block.

15. (canceled)

16. The system of claim 10, wherein the computing device is further configured to transmit a request to the user of the email account to verify that the pre-existing online listing should be updated based on the differences between the business data and the preexisting business data.

17. The system of claim 10, wherein the controller is further configured to determine whether to create a new online listing for the business entity if a pre-existing online listing is not available for the business entity.

18. A tangible, non-transitory computer-readable medium storing computer-executable instructions that, when executed by one or more processors, cause the one or more processors to perform operations, comprising:
providing access to an email account associated with a business entity;
receiving an indication of a change in a signature block associated with the email account, the signature block including business data related to the business entity;
accessing a business listing database to determine whether a pre-existing online listing is available for the business entity, the pre-existing online listing corresponding to a business listing that is different from the signature block associated with the email account;
if a pre-existing online listing is available for the business entity, comparing the business data contained within the signature block to pre-existing business data included within the pre-existing online listing; and
determining whether to update the pre-existing online listing based on any differences between the business data and the preexisting business data,
wherein determining whether to update the pre-existing online listing includes automatically transmitting, with the computing device, a request to a user of the email account to verify that the pre-existing online listing is associated with the business entity.

19. The computer-readable medium of claim 18, further comprising the operation of determining whether the change in the signature block corresponds to a change in the business data contained within the signature block.

20. The computer-readable medium of claim 18, wherein the operation of receiving the indication of the change in the signature block comprises comprise receiving a request associated with changing at least a portion of the business data contained within the signature block or a request associated with creating the signature block.

21. The computer-readable medium of claim 18, Wherein determining whether to update the pre-existing online listing further includes transmitting a request to the user of the email account to verify that the pre-existing online listing should be updated based on the differences between the business data and the preexisting business data.
